(19) United States
(12) Patent Application Publication
(10) Pub. No.: US 2005/0252771 A1
(43) Pub. Date: Nov. 17, 2005

(54) Method for operating a broadband lambda probe

(76) Inventors: Hans-Martin Wiedenmann, Stuttgart (DE); Lothar Diehl, Gerlingen (DE); Thomas Moser, Schwieberdingen (DE)

Correspondence Address: KENYON & KENYON, ONE BROADWAY, NEW YORK, NY, 10004, US

(21) Appl. No.: 10/510,397

(22) PCT Filed: Mar. 6, 2003
(86) PCT No.: PCT/DE03/00701

§ 371 Date: Jul. 14, 2005

(30) Foreign Application Priority Data
Apr. 16, 2002 (DE) 10216724.9

(51) Int. Cl. G01N 27/26

(52) U.S. Cl. 204/426

(57) ABSTRACT

A method for operating a broadband lambda sensor for determining the concentration of oxygen in the exhaust gas of an internal combustion engine operated with a fuel-air mixture is provided. In this method, a pump voltage (U_{P}) is applied to the pump cell of the sensor, this voltage-being set dependent on a Nernst voltage (U_{N}) tapped at the Nernst cell, and, dependent on the oxygen content of the exhaust gas, driving a cathodic or anodic pump current I_{P} via the pump cell. In order to maintain the measurement sensitivity of the sensor even during secondary fuel injection in lean operation and/or in “fast light off” operation, the polarity of the pump voltage (U_{P}) is repeatedly reversed during the duration of a secondary fuel injection and/or of the “fast light off” operation, so that an anodic pump current briefly arises that pumps oxygen ions into the measurement chamber, occupied by the measurement electrode of the Nernst cell and the inner electrode of the pump cell, in which chamber the oxygen ions oxidize the hydrocarbons.

### FIELD OF THE INVENTION

The present invention relates to a method for operating a broadband lambda sensor for determining the concentration of oxygen in the exhaust gas of an internal combustion engine operated with a fuel-air mixture.

### BACKGROUND INFORMATION

Published German patent document DE 198 38 466 describes a method for operating a broadband lambda sensor, in which, in order to break down a polarization effect at the lambda sensor, which would result in inaccuracies in the measurement value, after a longer period of lean operation of the lambda sensor, in which a cathodic pump current flows, a switching device is used to reverse the pump current in pulsed fashion, so that the inner electrode, which in lean operation is normally operated as a cathode, is briefly loaded in anodic fashion, and the direction of movement of the pumped oxygen ions is reversed. The frequency and duration of the pulses with which the polarity of the pump current is briefly reversed is dependent on the detection or Nernst voltage between the measurement, or Nernst, electrode and the reference electrode of the Nernst cell.

In order to reduce the same polarization effect of the inner electrode, which distorts the measurement value of the lambda sensor during long-term lean operation, German patent document DE 101 16 930 describes carrying out, during long-term lean operation, a pulsed operation of the pump cell with an extreme pulse-duty factor, in which the anodic pump current flowing via the pump cell from the outer to the inner pump electrode is reversed in very small intervals.

### SUMMARY

The method according to the present invention for operating a broadband lambda sensor has the advantage that during the lean operation of the internal combustion engine, in which a secondary injection of fuel into the combustion chamber of the internal combustion engine is carried out in order to protect, or maintain or improve the functioning of, components exposed to the exhaust gas, such as the oxidation catalytic converter and the particle filter, the sensitivity of the lambda sensor does not change as a result of the concomitant fuel enrichment in the exhaust gas. Such a secondary injection is carried out, for example, for the regeneration of a particle filter connected downstream from the catalytic converter, the uncombusted hydrocarbons in the exhaust gas being first combusted, i.e. oxidized, in the catalytic converter after the lambda sensor. Secondary injections of fuel are also carried out, for example, during a cold start, in the warmup phase of the internal combustion engine, for a rapid heating of the catalytic converter, in order to reach the full functional capacity thereof as quickly as possible. The loss or reduction of measurement sensitivity of the lambda sensor when there is a secondary fuel injection is due to the fact that during the secondary fuel injection enriched gas contacts the sensor, which is operating in lean operation, and the cathodically loaded inner electrode of the pump cell (cathodic pump current) is not sufficiently catalytically active to oxidize the hydrocarbons that travel through the diffusion block into the measurement chamber. In the measurement chamber, an increased concentration of hydrocarbons arises. As a result, the hydrocarbon concentration gradient sinks over the diffusion barrier, and reduces the hydrocarbon inflow.

An equivalent effect occurs in the run-up or warmup phase of the lambda sensor, which phase is also called “fast light off” and defined as the time from the activation of the power supply to the lambda sensor until the full functional capacity thereof. In this phase, the inner electrode of the pump cell is not yet sufficiently catalytically active to oxidize hydrocarbons that diffuse into the measurement chamber through the diffusion block.

The reversal of polarity of the pump voltage that is repeatedly carried out according to the present invention ensures that due to the repeated short-term anodic loading of the inner electrode of the pump cell, oxygen ions are pumped into the measurement chamber, where they oxidize the hydrocarbons. If the repetition rate of the reversal of polarity of the pump voltage is selected to be high enough, the dynamic characteristic of the sensor is not altered. At a sufficiently high electrode temperature, the oxygen transport can effectively follow the pump frequency, and the catalysis of the hydrocarbon conversion is improved.

According to an example embodiment of the present invention, for the repeated reversal of polarity of the pump voltage, a sequence of voltage pulses having constant amplitude is applied to the pump cell, and an effective pump current is set through pulse width modulation of the voltage pulses, dependent on the Nernst voltage of the Nernst cell.

In an alternative example embodiment of the present invention, for the repeated reversal of polarity of the pump voltage, a sequence of voltage pulses having constant pulse width is applied to the pump cell, and an effective pump current is set by modifying the amplitude of the voltage pulses, dependent on the Nernst voltage of the Nernst cell.

According to an example embodiment of the present invention, the frequency of the pulse sequence is selected at 10-2000 Hz, e.g., at 500 Hz. If the frequency of the pulse sequence is selected equal to the call rate of the lambda signal from the lambda sensor for the purpose of setting the fuel-air mixture of the internal combustion engine, this method can also be used to operate sensors having a lower operating temperature of, for example, 500° C.

According to an example embodiment of the present invention, the pulsed operation of the pump cell is maintained continuously, e.g., in lean and rich operation of the internal combustion engine, in order to maintain the catalytic characteristic of the inner electrode. In this way, there results a simplification in the design of the hardware and software of a control apparatus for controlling the broadband lambda sensor. In addition, other advantages are also achieved, such as the removal of the polarization voltage that is superposed on the Nernst voltage, leading to what is known as rich drift of the sensor.

### BRIEF DESCRIPTION OF THE DRAWINGS

FIG. 1 shows a cross-section of a broadband lambda sensor in connection with a schematic illustration of a control device and an associated internal combustion engine controlled by the control device.

FIG. 2 shows a diagram of a pump voltage pattern applied to the pump cell for the maximum possible voltage amplitudes.

FIG. 3 shows another diagram of a pump voltage pattern applied to the pump cell for the maximum possible voltage amplitudes.

FIG. 4 shows another diagram of a pump voltage pattern applied to the pump cell for the maximum possible voltage amplitudes.

FIG. 5 shows another diagram of a pump voltage pattern applied to the pump cell for the maximum possible voltage amplitudes.

### DETAILED DESCRIPTION

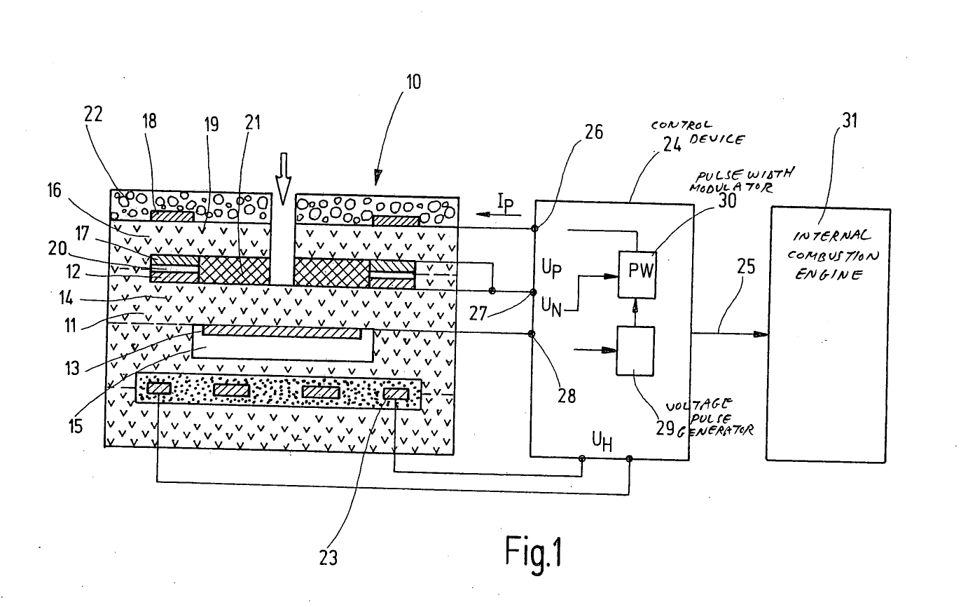

Broadband lambda sensor 10, shown in cross-section in FIG. 1, is used to determine the concentration of oxygen in the exhaust gases of internal combustion engines, in order to obtain a control signal for setting a fuel-air mixture with which the internal combustion engine is operated. Lambda sensor 10 has a measurement or Nernst cell 11 having a measurement electrode 12 and a reference electrode 13 that are situated on a solid electrolyte 14, as well as a pump cell 16 having an outer electrode 18 situated on solid electrolyte 19, which electrode 18 is also called an outer pump electrode, or OPE for short, and an inner electrode 17, also called the inner pump electrode (called IPN for short because it is at the same potential as the Nernst electrode), likewise situated on a solid electrolyte 19. As solid electrolytes 14, 19, a zirconium oxide stabilized with yttrium oxide is used, for example. Reference electrode 13 is situated in a reference canal 15 that is charged with a reference gas, e.g., air. Inner electrode 17 of pump cell 16 is situated, together with measurement electrode 12 of Nernst cell 11 (also called the Nernst electrode), in a measurement chamber 20 that is connected with the exhaust gas of the internal combustion engine via a diffusion barrier 21. Outer electrode 18 is covered with a porous protective layer 22 and is exposed directly to the exhaust gas. In addition, lambda sensor 10 has a heating device 23 formed by what is known as a heating meander (or zigzag heating element). Heating device 23 is charged with a heating voltage U_{H} and is held at a constant operating temperature of, for example, 780°.

For the operation of lambda sensor 10, this sensor is connected with a control device 24 that generates control signals for setting the fuel-air mixture in the internal combustion engine. In FIG. 1, the internal combustion engine is shown as block 31, whose controlling by control device 24 is shown through signal line 25. Pump-cell 16 is connected with control device 24 via terminals 26 and 27, outer electrode 18 being connected to terminal 26 and inner electrode 17 being connected to terminal 27. Nernst cell 11 is connected to control device 24 via terminals 27, 28, measurement electrode 12 being connected to terminal 27 and reference electrode 13 being connected to terminal 28. Between terminals 27 and 28, the detection or Nernst voltage U_{N} can be picked off, and pump voltage U_{P} is adjacent to terminals 26, 27. Control device 24 has a control circuit with which pump voltage U_{P} is set dependent on Nernst voltage U_{N}. The latter voltage is in turn dependent on the oxygen ratio to which measurement electrode 12 and reference electrode 13 are exposed. Control device 24 also has a voltage pulse generator 29 and a pulse width modulator 30 for controlling the pulse width of the voltage impulses or pulses.

Using the above-described control device 24, lambda sensor 10 is operated according to the following method:

On the basis of the difference in oxygen concentration between measurement electrode 12 and reference electrode 13, a particular Nernst voltage U_{N} arises that is a measure of the concentration of oxygen in measurement chamber 20. Dependent on Nernst voltage U_{N}, a pump voltage U_{P} adjacent to pump cell 16 is set that drives a pump current I_{P} via pump cell 16. Depending on the oxygen content of the exhaust gas, this pump current I_{P} is cathodic (as shown in FIG. 1) or is anodic, i.e., in the first case outer electrode 18 is operated as an anode and inner electrode 17 is operated as a cathode, and, conversely, in the second case outer electrode 18 is operated as a cathode and inner electrode 17 is operated as an anode. Given stable operation of internal combustion engine 31 with a fuel-air mixture in the lean range, pump current I_{P} is cathodic, i.e., inner electrode 17 of pump cell 16 is cathodically loaded. Given stable operation of internal combustion engine 31 with a fuel-air mixture in the rich range, pump current I_{P} is anodic, i.e., inner electrode 17 of pump cell 16 is anodically loaded. In the first case, oxygen ions are pumped out of measurement chamber 20, and in the second case oxygen ions are pumped into measurement chamber 20 from the exhaust gas. Here, pump voltage U_{P} is regulated in such a way that a constant oxygen concentration arises in measurement chamber 20, resulting in a constant Nernst voltage of, for example, 450 mV. The pump current I_{P} that arises is a measure of the oxygen concentration in the exhaust gas, and is acquired as a measurement voltage. The associated λ value is determined from a characteristic curve.

In lean operation of internal combustion engine 31, i.e., during operation of internal combustion engine 31 with a fuel-air mixture in the lean range, for particular cases of operation, e.g., for the regeneration of a particle filter situated downstream from a catalytic converter, control device 28 triggers secondary fuel injections in order to achieve a higher temperature through a combustion process, for example at the particle filter for particle removal. When this secondary injection takes place, hydrocarbons that are not combusted enter into the exhaust gas, and are combusted in the oxidation catalytic converter, thus heating up the particle filter. Because lambda sensor 10 is situated before the oxidation catalytic converter, the uncombusted hydrocarbons reach lambda sensor 10. Inner electrode 17 of pump cell 16, which in lean operation is cathodically loaded, is not sufficiently catalytic to oxidize the hydrocarbons that travel into measurement chamber 20 through diffusion barrier 21. As was described above, in this way the sensitivity of lambda sensor 10 decreases in an uncontrolled manner. However, in order to control lambda sensor 10 during the secondary injection it is necessary to acquire the lean and rich exhaust gas components completely. For this purpose, during the duration of a secondary fuel injection in lean operation a brief reversal of polarity of pump voltage U_{P} is carried out repeatedly, so that inner electrode 17 is repeatedly loaded anodically, and a pump current I_{P} oriented in the opposite direction arises briefly. In this way, oxygen ions are pumped into measurement chamber 20, where they oxidize the hydrocarbons. Due to this hydrocarbon conversion, the transport of oxygen out of measurement chamber 20 is now in turn possible when there is a cathodic pump current I_{P}. If the frequency of the reversal of polarity is selected sufficiently high, the dynamic characteristic of lambda sensor 10 is not altered. At a sufficiently high temperature of lambda sensor 10, the oxygen transport can effectively follow the pump frequency, and the catalysis of the hydrocarbon conversion is improved.

The repeated reversal of polarity of pump voltage U_{P} at pump cell 16 is achieved in that a sequence of voltage pulses having constant amplitude is applied to pump cell 16, these pulses being produced in voltage impulse generator 29, while, by means of pulse width modulator 30, the breadth, or width, of the voltage pulses is varied dependent on Nernst voltage U_{N} in such a way that an effective pump current I_{P} arises. The effective value of pump current I_{P} is equal to pump current I_{P} during direct-current operation of lambda sensor 10 in lean operation and rich operation of internal combustion engine 31.

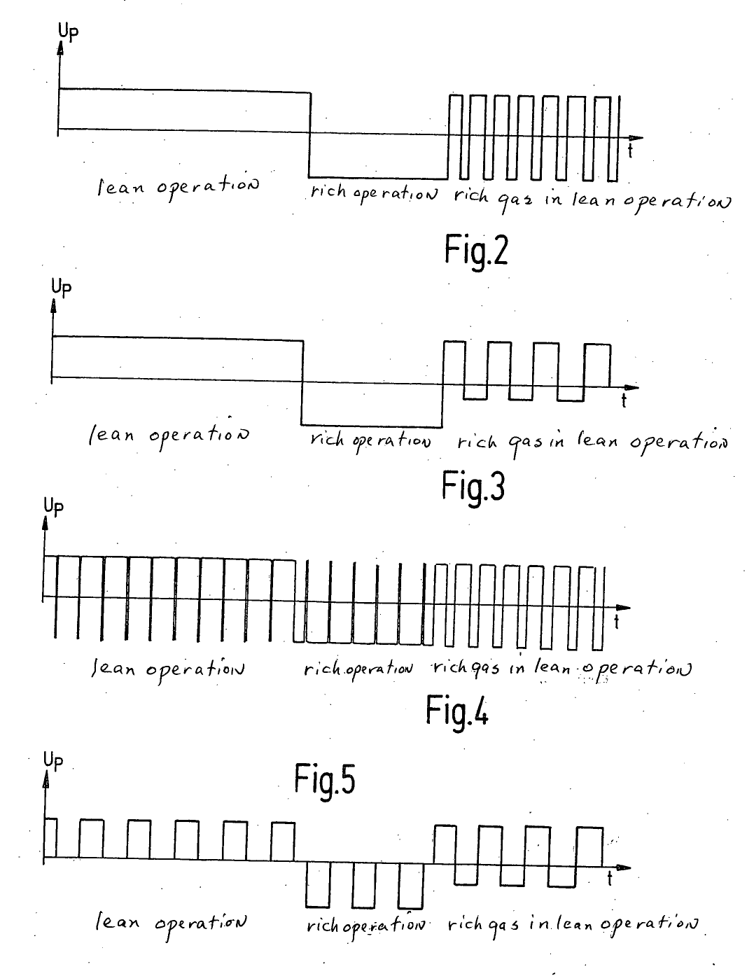

In FIG. 2, the pump voltage U_{P} at pump cell 16 is shown as a function of time t, for lean operation, for rich operation, and for lean operation with rich gas due to secondary fuel injection. Here, only the maximum pump voltage at outer electrode 18 is shown in comparison with inner electrode 17 of pump cell 16. As can be seen, in lean operation outer electrode 18 is anodically loaded, so that a cathodic pump current flows, through which oxygen ions are pumped out of measurement chamber 20. If the mixture composition of the internal combustion engine changes, and a lack of oxygen is detected in the exhaust gas, the polarity of pump voltage U_{P} is reversed, and inner electrode 17 is then anodically loaded. In this way, the oxygen ions from the exhaust gas are pumped into measurement chamber 20, so that the oxygen concentration in measurement chamber 20 is held constant even during the short-term rich operation caused by the secondary injection. In the last part of FIG. 2, pump voltage U_{P} is shown in lean operation during the secondary fuel injection. Due to the periodic reversal of polarity of pump voltage U_{P}, pump current I_{P}, which is in itself cathodic, is briefly reversed to form an anodic pump current I_{P}, the effective value of this anodic pump current I_{P} being determined by the width of the negative voltage impulses.

In a modification of the above-described operating method of lambda sensor 10, the repeated reversal of polarity of pump voltage U_{P} during the duration of a secondary fuel injection can also be realized with a pulse sequence of voltage pulses having a constant pulse width. In this case, the effective pump current I_{P} is set by modifying the amplitudes of the voltage pulses dependent on the Nernst voltage U_{N} of Nernst cell 16, as is shown in FIG. 3 in the area “rich gas in lean operation” during secondary injection.

In the cases of operations shown in both FIGS. 2 and 3, the frequency of the pulse sequence is selected between 10 and 2000 hertz. Here, a frequency of 500 hertz has been used. It has is also proven advantageous to use heating device 23 to raise the operating temperature of lambda sensor 10 during the times in which control device 24 activates the secondary injection, for example from 780° C. to 880°C.

Alternatively, the pulse sequence of the voltage pulses can be synchronized with the clock pulse with which the lambda signal, i.e., the effective pump current I_{P} that arises, is called for the controlling of the setting of the fuel-air mixture. In this case, the described method can also be used for lambda sensors 10 having a lower operating temperature, for example 500° C.

The above-described repeated reversal of polarity of pump cell 16 may be carried out beyond the phases of secondary injection, into the run-up or warmup phase of lambda sensor 10 as well, because here as well the sensitivity of lambda sensor 10 is disturbed by the slight catalytic effect of inner electrode 17 of pump cell 16. The run-up or warmup phase of lambda sensor 10 is defined by what is called “fast light off,” i.e., the time from the beginning of the application of current to lambda sensor 10 until this sensor reaches its full functional capacity.

In order to simplify the electronic circuit, the pulsed operation of lambda sensor 10 during secondary injection and/or “fast light off” can also be extended to the overall operation of lambda sensor 10 in the lean and rich ranges, as is shown in the voltage diagrams of FIGS. 4 and 5. In the same way as described for operations shown in FIGS. 2 and 3, the effective pump current I_{P} can be set either by pulse width modulation of the voltage pulses with constant amplitude (FIG. 4) or by amplitude variation of the voltage pulses with a constant pulse width (FIG. 5), both in lean operation and in rich operation, and (as already described) in the case of rich gas in the lean range due to secondary fuel injection.

The present invention is not limited to the depicted and described examples of the broadband lambda sensor. The method according to the present invention may also be used for the operation of a modified broadband lambda sensor having a flat design, e.g., of the type described in published German patent document DE 199 41 051.

1-7. (canceled)

8. A method for operating a broadband lambda sensor for determining an oxygen concentration in the exhaust gas of an internal combustion engine operated with a fuel-air mixture, the lambda sensor having a Nernst cell that has a measurement electrode and a reference electrode, the reference electrode being exposed to a reference gas in a reference canal, the lambda sensor also having a pump cell that has an outer electrode exposed to the exhaust gas and an inner electrode situated with the measurement electrode in a measurement chamber, the measurement chamber being separated from the exhaust gas by a diffusion barrier, the method comprising:
applying a pump voltage to the pump cell, the pump voltage being set dependent on a Nernst voltage that is present at the Nernst cell and that corresponds to the oxygen concentration in the measurement chamber;
driving, dependent on the oxygen content of the exhaust gas, one of a cathodic and anodic pump current via the pump cell, wherein the pump current is cathodic during a lean operation, the lean operation being defined as a stable operation of the internal combustion engine with a fuel-air mixture in a lean range, and wherein the pump current is anodic during a rich operation, the rich operation being defined as a stable operation of the internal combustion engine with a fuel-air mixture in a rich range; and
repeatedly reversing the polarity of the pump voltage during at least the lean operation to create a temporary reversal of direction of the pump current, wherein the repeated reversal of polarity of the pump voltage is carried out at least one of during the duration of a secondary fuel injection in the lean operation of the internal combustion engine and during a warm-up phase of the lambda sensor.

9. The method according to claim 8, wherein, for the repeated reversal of polarity of the pump voltage, a sequence of voltage pulses having a constant amplitude is applied to the pump cell, and an effective pump current is set by pulse width modulation of the voltage pulses dependent on the Nernst voltage of the Nernst cell.

10. The method according to claim 8, wherein, for the repeated reversal of polarity of the pump voltage, a sequence of voltage pulses having a constant pulse width is applied to the pump cell, and an effective pump current is set by modifying amplitudes of the voltage pulses dependent on the Nernst voltage of the Nernst cell.

11. The method according to claim 9, wherein the frequency of the sequence of the voltage pulses is between 10 Hz to 2000 Hz.

12. The method according to claim 11, wherein the frequency of the sequence of the voltage pulses is approximately 500 Hz.

13. The method according to claim 10, wherein the frequency of the sequence of the voltage pulses is between 10 Hz to 2000 Hz.

14. The method according to claim 13, wherein the frequency of the sequence of the voltage pulses is approximately 500 Hz.

15. The method according to claim 9, wherein the frequency of the sequence of the voltage pulses is equal to a call rate of a lambda signal for setting the fuel-air mixture of the internal combustion engine.

16. The method according to claim 10, wherein the frequency of the sequence of the voltage pulses is equal to a call rate of a lambda signal for setting the fuel-air mixture of the internal combustion engine.

17. The method according to claim 8, wherein an operating temperature of the lambda sensor is increased for at least one of duration of the secondary injection and duration of the warmup phase of the lambda sensor.

18. The method according to claim 9, wherein an, operating temperature of the lambda sensor is increased for at least one of duration of the secondary injection and duration of the warmup phase of the lambda sensor.

19. The method according to claim 10, wherein an operating temperature of the lambda sensor is increased for at least one of duration of the secondary injection and duration of the warmup phase of the lambda sensor.

20. The method according to claim 9, wherein the application of the sequence of the voltage pulses to the pump cell is maintained continually in lean and rich operation of the internal combustion engine.

21. The method according to claim 10, wherein the application of the sequence of the voltage pulses to the pump cell is maintained continually in lean and rich operation of the internal combustion engine.
